(19) United States
(12) Patent Application Publication
(10) Pub. No.: US 2007/0061854 A1
(43) Pub. Date: Mar. 15, 2007

(54) Apparatus, system and method for the transmission of a dynamic bandwidth signal across a catv network

(76) Inventors: Yechzkel Albag, Nordiya (IL); Zeev Orbach, Ashkelon (IL); Yeshayahu Strull, Tel Aviv (IL); Hillel Weinstein, New York, NY (US)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 10/535,822

(22) PCT Filed: Nov. 21, 2002
(86) PCT No.: PCT/IL02/00932

§ 371 Date: Sep. 22, 2005

(51) Int. Cl. H04N 7/173

(52) U.S. Cl. 725/95; 725/127

(57) ABSTRACT

A system and method for the transmission of a dynamic bandwidth dynamic content signal across a transmission-tiered communications network is disclosed. The network enables simultaneously the transmission of an extended-bandwidth signal carrying a full set of content information units and a set of unique CATV-standard-bandwidth signals carrying optionally different sub-sets of content information units selected specifically from the extended-bandwidth signal and delivered to targeted groups of subscribers. The unique CATV-standard-bandwidth signals are created by an extended signal-processing unit in response to specific control information generated in the network following particular requests submitted by the network the subscribers. Subsequently, the unique signals are transmitted to the subscribers via CATV-standard components.

### RELATED APPLICATIONS

The present application is related to co-pending PCT application No. PCT/IL00/00655 by Zeev Averbuch and Dr. Hillel Weinstein entitled “System and Method for Expanding the Operational Bandwidth of a Communication System”, filed 16 Nov. 2000 which is incorporated herein by reference.

### BACKGROUND OF INVENTION

1. Field of the Invention

The present invention relates to cable television distribution networks, in general and to an enhanced apparatus, system and method for transmitting a dynamic bandwidth signal carrying dynamic content across a CATV distribution network, in particular.

2. Discussion of the Related Art

Presently the signal transmitted across a standard cable television network infrastructure, from a head-end to a network subscriber, is modulated such as to have an operative bandwidth with a frequency range of from about 5 MHz to about 860 MHz. The signal carries diverse encoded information units, such as content, services and applications. Logically related and physically grouped information units are suitably modulated into distinct specifically allocated transmission channels. The channels are distributed across the available frequency range according to a predefined frequency plan. The number of potentially available downstream and upstream channels for the subscribers depends directly on the available bandwidth of the signal. The currently utilized signal with an about 5 to 860 MHz transmission bandwidth substantially limits the number of available downstream and upstream channels. Thus, in order to add new content to the existing programming mix the frequency range of the signal should suitably expanded.

The co-pending PCT patent application PCT/IL00/00655 describes and teaches a system and method for the substantial expansion of the operative bandwidth of a signal transported within a standard coaxial media-based cable television network. The system and method proposed by the above-mentioned patent application involves the installation and modification of a set of active and passive components along the signal transport path of the network in order to enable the transmission of a signal modulated across a frequency range of about 3 GHz and higher. The implementation of the proposed system and method specifically requires the upgrading of the CPE, such as the enhancement of the traditional set top boxes. The substantially expanded frequency range provides the option for the addition of a plurality of new channels to the existing programming mix. These channels would carry new content, information, services and applications in a bi-directional manner between the head end/hub stations and the network subscribers.

Presently all the subscribers linked to a specific head end or a specific hub station are provided with the entire set of available transmission channels allocated within the signal. Thus, if the signal having a particular bandwidth is transmitted along the transmission path while carrying 100 channels then the customer premises equipment of each of the associated subscribers will receive the same signal having the same bandwidth and carrying the same 100 channels. Although the subscriber is provided with the option of personalized programming, such as ordering, paying for and watching a specific package of desired channels only, the suitable filtering of the appropriate channels, such as the selection, the authorization and the de-coding of the requested channels are typically performed in a pre-determined manner within specific CPE units installed at the customer's premises. Note should be taken that in a realistic environment the majority of the customers are typically interested in receiving only a limited number of regularly supplied channels. Most customers are also interested in receiving periodically one or more channels on a temporary basis, such as, for example, a Video-on-Demand movie channel.

In accordance with the above-mentioned patent application, the set of components supporting the implementation of the system and method include several advanced subscriber interface units that have to be installed at the customer's premises. One such a component is a novel, enhanced and improved set top box that is designed to provide the option to the subscriber to tune to specifically selected channels located within the added frequency range portion of the extended bandwidth signal. The purchase of the technologically advanced customer premises equipment, specifically designed, developed and manufactured in order to support the substantially extended about 3 GHz transmission bandwidth, involves non-trivial expenses for the subscribers.

It would be easily understood by one with ordinary skills in the art that it would be advantageous to substantially expand the operational bandwidth of a cable television network for the purpose of adding new and useful content, information, services and applications for the network subscribers, while at the same time substantially preserving the existing configuration of the currently operating customer premises equipment and supporting the advanced operations through the existing components constituting the CPE configuration.

### SUMMARY OF THE PRESENT INVENTION

One aspect of the present invention regards a system for the transmission of a dynamic bandwidth signal across a transmission-tiered signal distribution network. The system comprises an at least one extended tap unit to receive a substantially extended bandwidth signal from an extended-bandwidth tier of the signal distribution network, to receive at least one control instruction transmitted from an at least one control interface associated with the signal distribution network, to generate a unique CATV-standard-bandwidth signal assembled specifically and selectively from frequency group elements constituting the received extended-bandwidth signal in accordance the at least one control instruction and to deliver the specifically and selectively generated CATV-standard-bandwidth signal to at least one targeted signal distribution network subscriber via an at least one CATV-standard-bandwidth transmission tier of the signal distribution network.

A second aspect of the present invention regards a method for the transmission of a dynamic bandwidth signal across a transmission-tiered signal distribution network. The method comprises the steps of; delivering via a CATV-standard-bandwidth transmission tier portion of a signal distribution network to an at least one extended tap unit a unique CATV-standard-bandwidth signal carrying at least one service request from at least one signal distribution network subscriber, converting the unique CATV-standard-bandwidth signal carrying the at east one service request into an extended-bandwidth signal by the at least one extended tap unit; delivering via an extended-bandwidth transmission tier portion of the signal distribution network to a network head-end or to a network hub station the extended-bandwidth signal carrying the at least one service request from at least one signal distribution network subscriber, generating suitable control information via a control interface associated with the network head-end or the network hub station, transmitting the generated control information from the network head-end or the network hub station; manipulating in accordance with the transmitted control information the operation of the at least one extended tap unit, controlling in accordance with the transmitted control information the customer premises equipment associated with the at least one network subscriber; generating at the network head-end or at the network hub station an extended-bandwidth signal selectively including frequency group elements associated with the services required by the at least one network subscriber, delivering the extended-bandwidth signal via the extended-bandwidth transmission tier of the signal distribution network to the at least one extended tap unit; frequency-converting and selectively filtering the extended-bandwidth signal into a unique CATV-standard-bandwidth signal in accordance with the received control information by the at least one extended tap unit; and delivering the unique CATV-bandwidth signal via the CATV-standard-bandwidth transnission tier of the signal distribution network to the at least one network subscriber.

### BRIEF DESCRIPTION OF THE DRAWINGS

The present invention will be understood and appreciated more fully from the following detailed description taken in conjunction with the drawings in which:

FIG. 1 is a schematic block diagram showing an exemplary configuration for the cable plant of a transmission-tiered CATV network (upgraded to 3 GHz bandwidth), in accordance with a preferred embodiment of the present invention;

FIG. 2A illustrates the frequency allocation for a CATV signal transported across the extended-bandwidth-transmission-tier of the transmission-tiered CATV network, in accordance with a preferred embodiment of the present invention;

FIG. 2B illustrates the frequency allocation of the signal in the CATV-standard-bandwidth-transmission-tier of the transmission-tiered CATV network, in accordance with a preferred embodiment of the present invention;

FIG. 3 is a schematic block diagram illustrating the operative components constituting an exemplary extended tap device, in accordance with a preferred embodiment of the present invention;

FIG. 4 is a schematic block diagram showing the operative components constituting an exemplary subscriber module associated with the extended tap device, in accordance with a preferred embodiment of the present invention; and

FIG. 5 is a perspective view of the extended tap device, in accordance with a preferred embodiment of the present invention.

### DETAILED DESCRIPTION OF THE PREFERRED EMBODIMENT

PCT Patent application Serial No. PCT/IL00/00655 by Zeev Averbuch and Dr. Hillel Weinstein entitled “System and Method for Expanding the Operational Bandwidth of a Communication System”, within which a method and system for the substantial expansion of the usable bandwidth of a CATV network is disclosed, is incorporated herein by reference.

An apparatus, system and operating method for the transmission of a dynamic bandwidth dynamic content signal across a transmission-tiered communications network is disclosed. Although in the preferred embodiment of the present invention the transmission-tiered communications network is implemented in a cable television communications network (CATV) primarily distributing video and/or multimedia content it would be easily understood that in other preferred embodiments the proposed system and method could be applied to diverse other communications networks such as satellite communications networks, Local Area Networks (LANs), Wide Area Networks (WANs), or any other communications network involving the two-way delivery of information units between a central location and users located remotely in respect to the central location. The system and method proposed could also be utilized in a peer-to-peer network operative in the delivery of information units between remote or local users. The content delivered by the relevant communications networks could be of any distributable material, such as voice, images, video, data structures, graphics, executable code, rich media, text and the like.

The different transmission tiers of the proposed CATV distribution network are characterized by pre-defined frequency ranges of CATV signals carrying a set of pre-defined information units that are transported across pre-defined sections of the cable plant. The proposed apparatus, system and method involves the configuration of the CATV distribution network such that a first transmission tier enables the two-way transmission of an extended bandwidth signal carrying a full set of available information units while a second transmission tier enables the two-way transmission of one or more signals having a CATV-standard-bandwidth and carrying optionally different sub-sets of information units. Although in the preferred embodiment of the invention the CATV distribution network is constructed such as to have two transmission tiers in other preferred embodiments additional transmission tiers could be added where each transmission tier would be responsible for the two-way transportation of one or more CATV signals modulated across different frequency ranges and carrying optionally different information units. The interfacing of the transmission tiers is achieved by the linking thereof via specifically designed and developed signal processor/signal distributor units operative in the dynamically determined selective conversion of the signals by frequency-converting and selectively filtering selected portions of an input signal received from the first transmission tier having a wide frequency range and by the consequent dynamic allocating of the frequency-converted and selectively filtered selected frequency elements into selected frequency ranges of one or more output signals, which are fed into the second transmission tier.

In the preferred embodiment of the invention, a CATV network is provided with an extended-bandwidth-transmission-tier that extends from a network head-end or a hub station to a series of extended tap units. The extended-bandwidth-transmission-tier carries and maintains a signal that is modulated across a substantially extended frequency range of about 5-3000 MHz and above. This extended bandwidth signal is carried and maintained across the extended-bandwidth-transmission-tier of the CATV network by utilizing the system and method proposed by the above-mentioned related patent application. The extended-bandwidth signal is fed into the set of extended tap units installed across the cable plant and selectively processed therein. The extended tap units are linked to a set of network subscribers. Pre-defined frequency elements of the extended-bandwidth signal are dynamically frequency-converted and selectively filtered by specific components of the extended tap units in accordance with specific programming instructions transmitted from the head end/hub stations, in order to dynamically generate one or more signals carrying specifically defined information units where each specific signal is frequency-converted and selectively filtered across a CATV-standard frequency range of about 5-860 MHz. The signals modulated across the CATV-standard frequency range are fed from the extended tap units to a CATV-standard-bandwidth-transmission-tier section of the network. The CATV-standard-bandwidth-transmission-tier extends from the extended tap devices to the Customer Premises Equipment (CPE) associated with pre-defined set of network subscribers. The CATV-standard-bandwidth signal is carried and maintained across the CATV-standard-bandwidth-transmission-tier of the network by utilizing the standard components of the currently existing standard CATV distribution networks.

The following description of the preferred embodiment is meant to provide a ready understanding of the present invention. The embodiment-specific descriptions of the various components and operational methods are not meant to be limiting. The limits of the present invention will be defined only by the following claims.

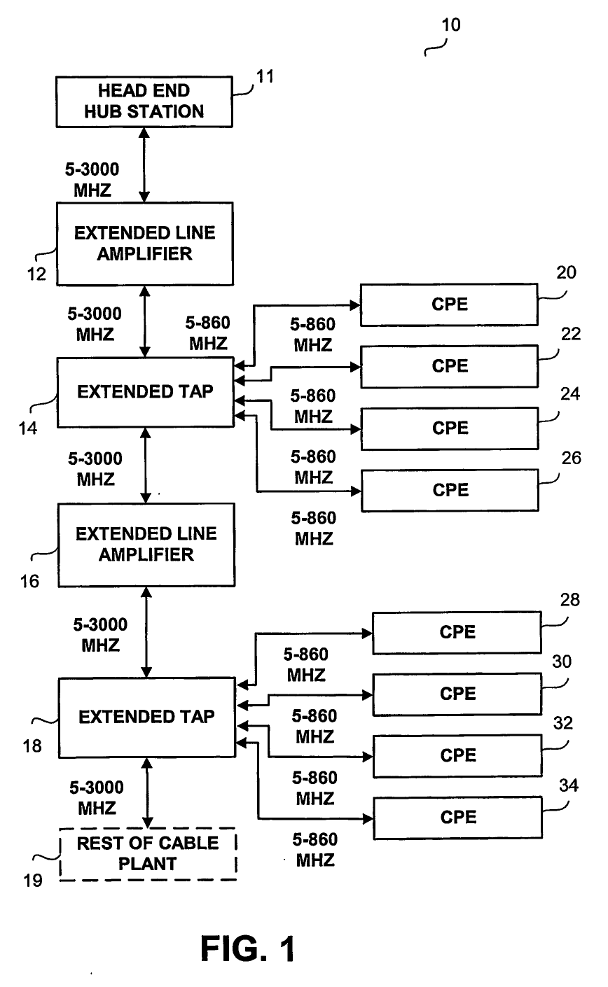

Referring now to FIG. 1 illustrating an exemplary simplified configuration for a cable plant of a transmission-tiered CATV network 10. The network 10 comprises a head end/hub station 11, a set of extended line amplifiers 12, 16, a set of extended tap devices 14, 18 and a set of CPE 20, 22, 24, 26, 28, 30, 32 and 34. A CATV signal modulated across a substantially expanded frequency range is generated at the head end/hub station 11 and delivered across the cable plant in a bidirectional manner. The CATV signal carries a plurality of information units containing pre-defined content, such as control data, video/audio objects, programs, services and applications, The head end/hub station 11 is linked via coaxial cables, via a first extended line amplifier 12 and via a first extended tap device 14 to a first set of CPE 20, 22, 24, 26 associated with a first set of network subscribers. The first extended tap device 14 is further linked via coaxial cables to a second extended line amplifier 16, which is linked in turn to a second extended tap device 18. The second extended tap device 18 is linked to a second set of CPE 28, 30, 32, 34 associated with a second set of network subscribers. The CATV signal is transported from the first extended tap device 14 via the second extended line amplifier 16 and via the second extended tap device to the second set of CPE 28, 30, 32, 34 associated with the second set of network subscribers. The second extended tap device 18 is further linked to the continuance of the CATV network 19 and feeds the CATV signal to additional extended line amplifiers, extended tap devices and additional sets of CPE in the rest of the CATV cable plant. It will be easily perceived that although on the drawing under discussion only two extended line amplifiers, two extended tap devices and two sets of CPEs are shown, in a realistic environment the cable plant 10 comprising a plurality of extended line amplifiers, a plurality of extended tap devices and a plurality of CPEs. A realistically configured network would also include a plurality of hub stations and additional hardware components along the transmission path.

The signal having a substantially expended frequency range is generated, delivered and maintained via the utilization of specific electronic components designed and developed according to the description and teachings of the above-mentioned related patent application. A more detailed description of the components operative in the handling of the substantially expanded signal, such as structure and functionality of the extended line amplifiers, is included in the text of the above-mentioned related patent application.

In the preferred embodiment of the invention the substantially expanded CATV signal is modulated across an about 5-3000 MHz frequency range. In other embodiments a wider frequency range could be provided. The network 10 is conceptually constituted of two transmission tiers where the different transmission tiers are characterized by different frequency ranges of the transmitted signal. Thus, the first transmission tier of the network 10 includes the head end/ hub station 11, the extended line amplifier 12, a first transmission tier component of the extended tap device 14, the second extended line amplifier 16, the first transmission tier component of the second extended tap device 18, and the coaxial cables interconnecting the first transmission tier elements. The infrastructure of the first transmission tier enables the two-way transmission of the extended bandwidth CATV signal modulated across the about 5-3000 MHz frequency range. The extended bandwidth CATV signal carries a plurality of transmission channels along the entire length of the cable plant backbone where the number of channels, the allocation plan of the channels within the frequency range and the content of the information units carried is non-changeable within the first transmission tier.

The second transmission tier of the CATV network 10 includes the second transmission tier component of the first extended tap device 14, the second transmission tier component of the second extended tap device 18, the first set of the CPE 20, 22, 24, 26 associated with the first set of network subscribers, the second set of the CPE 28, 30, 32, 34 associated of the second set of network subscribers and the coaxial cables interconnecting the operative elements of the second transmission tier. The infrastructure of the second transmission tier enables the two-way transmission of a set of signals modulated across modulated across the CATV-standard-bandwidth of about 5-860 MHz frequency range. The CATV-standard-bandwidth signals carry a sub-set of the transmission channels provided by the extended-bandwidth CATV signal fed from the first transmission tier to the second transmission tier. The number of channels, the frequency allocation plan and the content carried by the channels in the CATV-standard-bandwidth signal could optionally differ where each optionally different CATV-standard-bandwidth signal is fed to a specific CPE 20, 22, 24, 26, 28, 30, 32 and 34.

The interface between the first transmission tier and the second transmission tier within the network 10 is provided by specifically designed and developed signal processing components installed in the first extended tap device 14 and the second extended tap device 18. A more detailed description of the signal processing components implemented in the tap devices 14, 18 will be set forth herein under in association with the following drawings. In addition to the conversion of the extended-bandwidth signal to a set of CATV-standard signals the first extended tap device 14 and the second extended tap device 18 is responsible for the suitable distribution of the CATV-standard signals to the CPE 20, 22, 24, 26 and to the CPE 28, 30, 32, 34 respectively. The unique characteristics of the various CATV-standard-bandwidth signals distributed to the respective network subscribers are provided by specific programming instructions generated in the head end/hub station 11 of the network 10 and by the specific functionality of the processing components implemented in the extended tap devices 14 and 18. The instructions concerning the unique characteristics of the CATV-standard-bandwidth signals are initiated by specific requests submitted by the individual subscribers and are delivered from a specific control interface, such as the Cable Modem Termination System (CMTS) interface implemented in head end/hub station 11 to the first extended tap device 14 and the second extended tap device 18. These instructions dynamically determine the appropriate content and associated frequency plan of the signals generated in the respective extended tap devices.

The structure of above-described network and the constituent components are exemplary only. An extremely simplified configuration is shown for the simplicity of the description and ready understanding of the underlying principles of the present invention. The network 10 could include a plurality of hub stations feeding a plurality of network subscribers via a plurality of distribution branches. For example, a single extended tap device could distribute a plurality of optionally unique CATV-standard-bandwidth signals to a plurality of CPEs associated with a plurality of network subscribers. Furthermore, the network 10 is shown in a substantially schematic manner such that diverse components operative in the proper transmission and distribution of the signals and for the appropriate operation of the network are not shown.

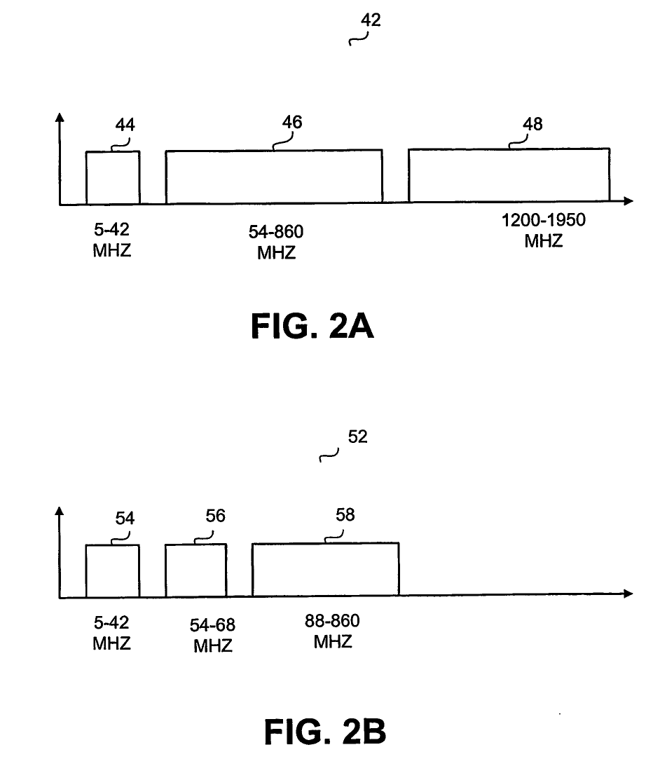

Referring now to FIG. 2A the extended-bandwidth signal 42 is modulated across the frequency range of about 5-1950 MHz. The frequency plan of the signal 42 allocates the about 5-42 MHz frequency portion 44 to the transmission of the upstream traffic generated typically by the CPEs automatically and/or manually by network subscribers. The about 54-860 MHz frequency range portion 46 carries the downstream traffic that carries a plurality of standard transmission channels from the head end/hub station to the subscribers. The about 1200-1950 MHz frequency range portion 48 is the extended portion of the frequency range provided by the system and method of the above-mentioned related patent application. The about 1200-1950 MHz frequency range portion 48 includes additional transmission channels modulated into the extended-bandwidth signal at the head end/hub station. These additional transmission channels would provide additional services and applications, such as Video-on-Demand movie channels, data communication network access and delivery channels and the like. The extended-bandwidth signal is generated at the head end/hub station utilizing diverse external or local information sources and delivered in a bi-directional manner across the first transmission tier of the CATV network. The extended-bandwidth signal 42 is fed into the extended tap units installed at pre-determined intervals along the cable plant. The extended tap devices receive the extended-bandwidth signals and selectively process the signal such that the original extended-bandwidth signal is fed to the continuance of the cable plant while the same signal is re-split and processed dynamically and individually for each of the CPEs serviced by the extended tap unit.

The above-described frequency plan of the signal 42 is exemplary only. In other embodiments of the invention different frequency allocations could be provided. Thus, the extended frequency range portion 48 could span a substantially wider frequency range, such as about 1200-3000 MHz, for example.

Referring now to FIG. 2B a specific CATV-standard-bandwidth signal 52 is modulated across the CATV-standard frequency range of about 5-860 MHz. The frequency plan of the signal 52 allocates the about 5-42 MHz frequency portion 54 to the transmission of the upstream traffic generated by the network subscribers. The about 88-860 MHz frequency range portion 58 carries the downstream traffic that includes the standard pre-defined package of CATV channels transmitted from the head end/hub station to the subscribers in the conventional CATV networks. The signal 52 further includes a dynamically allocated about 48-68 MHz frequency range portion 56 that carry subscriber-specific information units, such as a Video-on-Demand (VoD) transmission channel carrying a movie in the HDTV format and the like that was specifically requested for viewing by a subscriber.

Referring now to FIGS. 2A and 2B the structure of the signal 52 shown on FIG. 2B is produced in the extended tap units via the suitable frequency conversion and selective filtering of the signal 42 shown on FIG. 2A. The signal 42 is processed by the extended tap units such that pre-defined frequency range portions of the signal 42 are inserted into the signal 52 while other frequency portions of the signal 42 carrying information units requested by a serviced subscriber are dynamically frequency-converted and selectively filtered in accordance with suitable programming instructions received from the CMTS interface implemented in the head end/hub station and inserted into the signal 52.

The above-described frequency plan of the signal 52 is exemplary only. In other embodiments of the invention different frequency allocation could be provided. Thus, the dynamically created about 48-68 MHz frequency range portion 56 could be frequency-converted and selectively filtered to a different frequency portion across the CATV-standard-bandwidth signal.

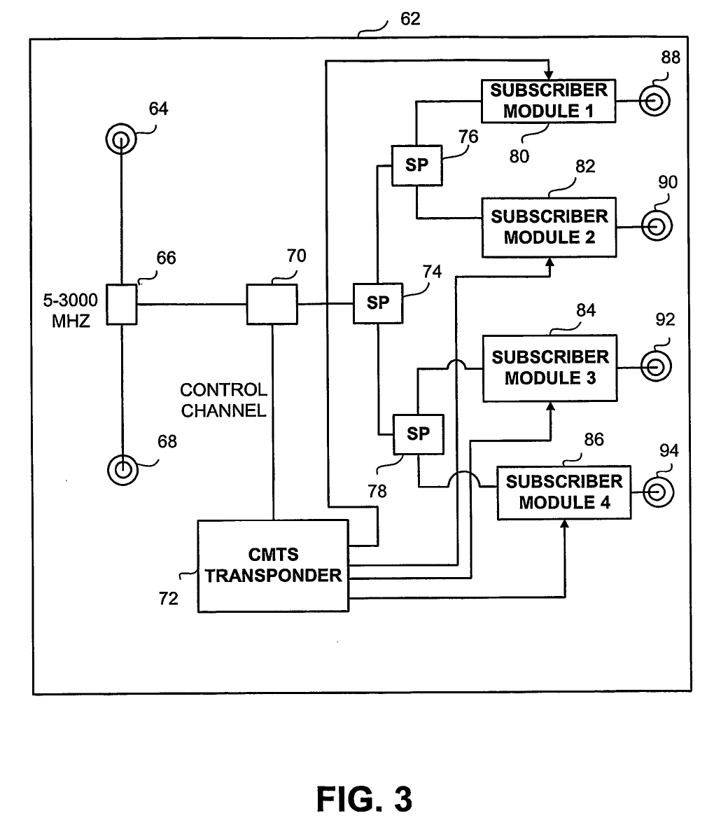

Referring now to FIG. 3 the extended tap device 62 comprises an input port 64, a splitter 66, an output port 68, a CMTS transponder 72, a frequency selective circuit 70, the splitter devices 74, 76, 78, the subscriber modules 80, 82, 84, 86 and the output ports 88, 90, 92, 94. The extended-bandwidth signal with a frequency range of about 5-3000 MHz is fed from the cable plant to the extended tap unit 62 via the input port 64. The signal is split at splitter 66 and fed via the output port 68 to the continuance of the cable plant. The signal is substantially simultaneously fed into the processing portion of the extended tap device 62. The frequency selector circuit 70 separates the downstream control channel from the signal. The downstream control channel includes the CMTS instructions transmitted from the CMTS interface of the head end/hub station. The instructions are fed to the CMTS transponder 72 for decoding and for feeding the subscriber units 80, 82, 84 and 86 where each subscriber module is associated with a specific subscriber. The about 5-3000 MHz extended-bandwidth signal is split by the splitter 74 and consequently by the splitters 76 and 78 to enable the feeding of the signal to the subscriber modules 80, 82, 84 and 86. The extended-bandwidth signal is processed within the subscriber modules 80, 82, 84 and 86 in a unique manner in accordance with the CMTS instructions fed into the modules from the CMTS transponder 72. The subscriber modules 80, 82, 84 and 86 generate four optionally unique CATV-standard-bandwidth signals having a frequency range of about 5-860 MHz and distribute the signals via the output ports 88, 90, 92 and 94 to the respective CPE of the respective network subscribers. It would be easily perceived that the extended tap device 62 is capable of generating more than four unique output signals. In other preferred embodiments of the invention, 16, 32 or more subscriber modules and associated output ports could be implemented and thereby generating 16, 32 and more optionally unique CATV-standard-bandwidth output signals.

The configuration of above-described device is exemplary only. In other embodiments of the invention different components could be in configuration to provide for the substantially same principle of operation.

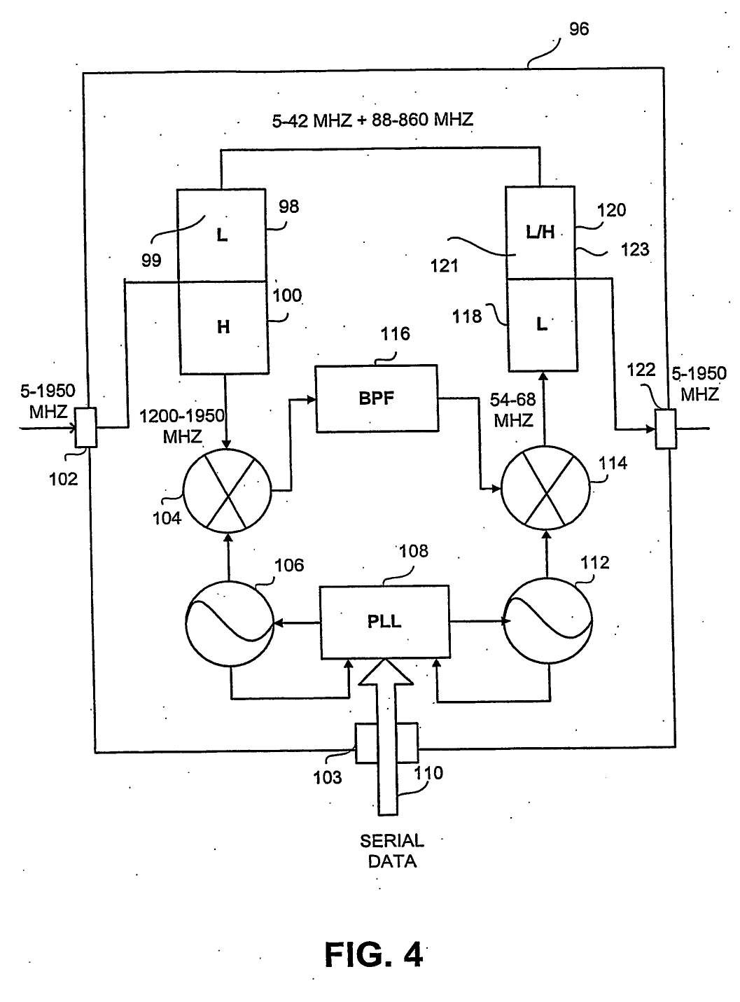

Referring now to FIG. 4 the subscriber module 96 is operative in the generation of a subscriber-specific CATV-standard-bandwidth signal carrying unique information units requested by the specific subscriber. The module 96 is a specifically designed and developed hardware device, such as an Application Specific Integrated Circuit (ASIC) that is implemented in the extended tap unit. A separate subscriber unit 96 is implemented for each subscriber linked to the extended tap device. Each subscriber module 96 operates in a unique manner in accordance with specific programming instructions generated by the submittal and upstream delivery of the subscriber requests to the CMTS in the head end/hub station and transmitted from the CMTS downstream to the subscriber module 96. The module 96 comprises a first input port 102, a second input port 103, a diplexer 99, a triplexer 121, a band pass filter 116, an output port 122, a PLL micro controller device 108, the mixers 104, 144 and the Voltage Control Oscillators (VCOs) 106, 112. The diplexer 99 includes a low pass filter section 98 and a high pass filter section 100. The triplexer circuit 121 includes a low pass filter section 120, a high pass filter section 123 and a low pass filter section 118. The extended-bandwidth signal is fed via the input port 102 to the diplexer 99. The low pass filter section 98 of the diplexer 99 separates the about 5-42 MHz band and the about 88-860 MHz band of the signals and feeds the separated bands to the low pass filter section 10 and high pass filter section 123 of the triplexer 121. The about 1200-1950 MHz band of the extended-bandwidth signal is separated by the high pass filter section 100 of the diplexer 99 and fed to the mixer 104. Control data 110 from the CMTS is fed via the input port 103 into the PLL controller 108. The controller 108 controls the VCOs 106, 112 that in turn control the mixers 104, 114. A dynamically selected about 48-68 MHz frequency band including typically a transmission channel requested by a subscriber is passed to the low pass filter section 118 of the triplexer 121. The about 5-42 MHz band and the about 88-860 MHz band are combined by the about 48-68 MHz band and fed via the output port 122 to the specific subscriber.

Still referring to FIG. 4 the PLL micro controller 108 manipulates the VCO/mixer such as to effect the selection of a specific frequency range carrying a specific transmission channel from the about 1200-1950 MHz band. The selected frequency band overlays the about 5-860 frequency band such as not to interfere with the transmission of the standard programming package of channels within the about 5-860 MHz band.

The configuration of above-described device is exemplary only. In other embodiments of the invention different components could be in configuration to provide for the substantially same principle of operation.

The optionally subscriber-specific CATV-standard-bandwidth signals generated by the subscriber-specific subscriber modules are fed into the CATV-standard-bandwidth transmission tier of the network, which extends from the extension tap device output port to the CPE of the customer. Since this tier is responsible for the transmission and maintenance of a CATV-standard-bandwidth signal the necessity of replacing or complementing equipment in the extension tap device-CPE network branch of the network is negated. As a result the installation costs associated with the implementation of the proposed apparatus and system are substantially reduced.

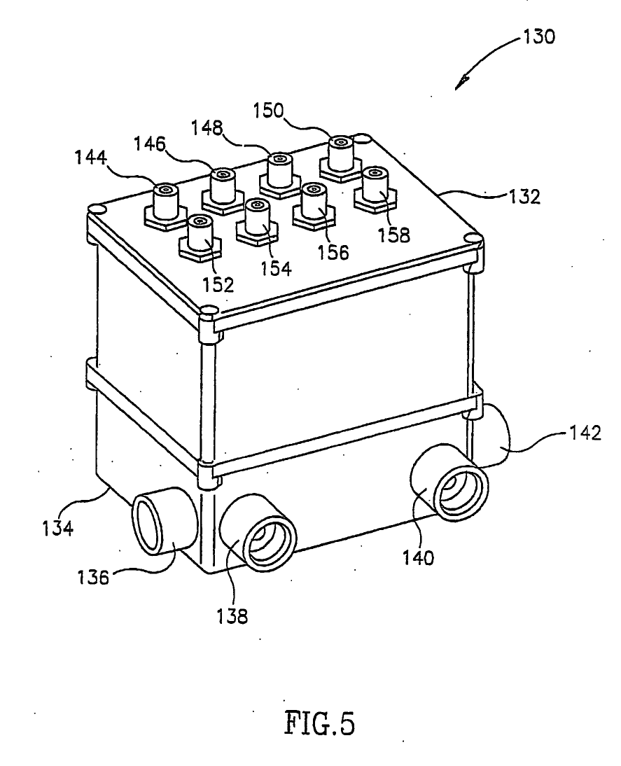

Referring now to FIG. 5 the extension tap device 130 includes a device body 132 that encloses the internally installed operative components of the device 130. On the lower external surface of the body a set of connector devices 136, 138, 140, 142 is installed. The connectors 136, 138, 140 and 142 are operative in receiving the extended-bandwidth signal transmitted from the head end/hub station of the cable plant and in forwarding the signal to the continuance of the cable plant. On the upper external surface of the device body 132 a set of connectors 144, 146, 148, 150, 152, 154, 156 and 158 is installed that provide a set of optionally unique CATV-standard-bandwidth output signals to a set of CPEs associated with a set of linked network subscribers. Although on the drawing under discussion only a limited number of output connectors are shown it would be easily perceived that in other preferred embodiments of the invention a plurality of output connectors could be installed to provide a plurality of CATV-standard-bandwidth signals to a plurality of associated network subscribers.

Both the CATV-standard-bandwidth signals in the second transmission tier of the network and the extended-bandwidth signal in the first transmission tier of the network are transported in a bidirectional manner in the downstream and in the upstream direction. Thus splitters are utilized as combiners when operating on the upstream signals. The extended tap devices receive the CATV-standard-bandwidth signals from the subscribers in the upstream, separate the about 5-42 MHz bands from the received signals and insert the subscriber-specific frequency bands into the about 5-42 MHz band of the extended-bandwidth signal in the upstream.

The method for the operation of the system will be described next. A network subscriber submits a request to the system for concerning the viewing of a VoD channel carrying an HDTV-formatted movie. The requests effects the generation of suitable control information by the standard about 5-860 MHz set top box and is transmitted upstream on the about 5-42 MHz return path. The control information is received by the CMTS in the head end/hub station, which consequently sends two messages in the downstream direction: 1) to the set top box to set the input channel to the HDTV service channel carried in the frequency range of about 54-68 MHz and/or any other designated channel, and b) to the extension tap device to set the specific subscriber tuner to the selected channel included in the 1200-1950 MHz range. The reception of the messages is then confirmed by both the set top box and the extension tap device where the confirmation messages are delivered upstream in the about 5-42 MHz frequency band. Consequently a specific information unit server device in the head end/hub station is activated and downloads the selected movie to the set top box of the requesting subscriber via the extension tap device. The information server activates an accounting module for the computation of the specific price for the download and the appropriate charging of the subscriber's account. The exclusive viewing of the movie by the specific subscriber only is achieved by the automatic programming of the associated set top box that affects the setting of the set top box to the selected channel. Optionally frequency hopping techniques and other security-related technologies could be used between the selected output and the input channels to provide for further security.

The proposed apparatus, system and method provides for the transmission, handling and maintenance of a dynamically manipulated CATV signal across different transmission tiers of the network where each tier handles a signal with differing characteristics. The characteristics involve different frequency ranges, differing frequency plans, and unique content in accordance with specific requests submitted by specific subscribers. Thus the main transmission path of the network transports an extended bandwidth signal that includes the entire set of available transmission channels while the diverse subscriber-specific transmission branches transport a CATV-standard-bandwidth signal, which is selectively generated from the extended bandwidth signal in accordance with a combination of pre-defined subscriber-specific frequency plan and specific demands concerning the delivery of particular content to a subscriber. The salient features of the proposed apparatus, system and method include the following: a) the requirement concerning the upgrading/replacement/complementing the equipment installed at the customers premises is negated, b) the delivery of a specific HDTV VoD channel is enabled to a specific subscriber in a dynamic manner in a secure manner by the automatic tuning of the set top box to a specific channel, c) the apparatus, system and method is fully compatible with the system and method proposed by above-mentioned related patent application, d) the CATV operator is provided with the option of selecting and implementing a unique frequency/channel allocation for a specific available service, e) optionally the entire set of the network subscribers are provided with the capability of an viewing HDTV VoD movie in an identical channel, f) no additional hardware components are needed to be installed at the head end/hub stations, g) standard DOCSIS (CMTS) control system and billing could be used, h) only the first transmission tier (cable plant backbone) should be upgraded to the about 5-3000 MHz signal delivery where the update involves the utilization of the components proposed by the above-mentioned related patent application, I) the low cost extension tap devices have the capability of supporting a diverse number of subscribers (4/6/8/16/32), j) low power consumption, k) easy installation, 1) the technology provides the option for the implementation of virtual node splitting, m) a delivery rate of 38 Mb/sec or 76 Mb/sec per subscriber is assured, and m) the technology enables a potential delivery of 220 HDTV VoD channels simultaneously in the first transmission tier.

The proposed apparatus, system, and method provides the option of selectively partitioning the transported media carried by a signal having a substantially extended frequency range both in the downstream and the upstream and the option of delivering the partitioned media to/from a specifically targeted, suitably configured and appropriately limited group of subscribers. The above options are achieved while maintaining the network's curb-to-subscriber infrastructure segments intact. Thus, the necessity of modifying, adding, or deleting any passive or active components, such as set top boxes, modes or the like within the network's curb-to-subscriber infrastructure segments is substantially negated.

It will be appreciated by persons skilled in the art that the present invention is not limited to what has been particularly shown and described hereinabove. Rather the scope of the present invention is defined only by the claims, which follow.

1-18. (canceled)

19. An extended tap unit to distribute extended bandwidth signals of a transmission-tiered distribution network supporting a wide frequency band including a CATV-standard frequency band and an extended frequency band, said extended tap unit comprising:
an input port to receive from an extended-bandwidth tier of said distribution network an extended downstream signal carrying extended downstream data modulated over at least one sub-band of said extended frequency band; and
at least one signal distribution network subscriber module to generate, based on said extended downstream signal, at least one respective subscriber signal within said standard frequency band, said at least one subscriber signal carrying the extended downstream data of at least one sub-band modulated over a predetermined sub-band of said standard frequency band, respectively.

20. The extended tap unit of claim 19 comprising at least one subscriber output port to transmit said at least one converted signal to at least one respective subscriber over a CATV-standard-bandwidth tier of said distribution network.

21. The extended tap unit of claim 19 comprising a control instructions interface transponder to control said at least one subscriber module to selectively generate said at least one subscriber signal based on a control instruction received from said distribution network.

22. The extended tap unit of claim 21, wherein said at least one subscriber comprises at least one targeted subscriber intended to receive the downstream data of said at least one sub-band, respectively, and
wherein said control instruction comprises an instruction associating between said at least one sub-band and said at least one targeted subscriber, respectively.

23. The extended tap unit of claim 21, wherein said extended downstream signal carries standard downstream data modulated over at least a portion of said standard frequency band.

24. The extended tap unit of claim 23, wherein said subscriber module comprises:
a diplexer to generate a standard downstream data signal within said standard frequency band, and an interim downstream data signal within said extended frequency band, by filtering portions of said extended downstream signal, said standard downstream signal carrying said standard downstream data, and said interim downstream data signal carrying the extended downstream data modulated over said at least one frequency sub-band;
a converter to selectively convert said interim data signal, based on said control instruction, into an extended data signal carrying the extended downstream data modulated over the predetermined sub-band of said standard frequency band; and
a triplexer to generate said subscriber signal by selectively combining said standard downstream data signal and said extended data signal.

25. The extended tap unit of claim 24, wherein said triplexer is able to receive from a CATV-standard-bandwidth tier of said distribution network a standard upstream signal within said CATV-standard frequency sub-band, and to route said standard upstream signal to said diplexer; and
wherein said diplexer is able to route said standard upstream signal to said extended-bandwidth tier.

26. The extended tap unit of claim 19, wherein said subscriber module is able to receive from said CATV-standard-bandwidth tier a standard upstream signal within said CATV-standard frequency sub-band; and to transmit said standard upstream signal to said extended bandwidth tier.

27. The extended tap unit of claim 19 comprising:
a network output port; and
splitter to split said extended downstream signal into a first signal to be provided to said at least one subscriber module, and a second signal to be provided back to said extended bandwidth tier via said network output port.

28. The extended tap unit of claim 19, wherein the predetermined portion of said standard frequency band comprises at least a sub-set of the frequency band of 54-68 MHz.

29. The extended tap unit of claim 19, wherein said wide frequency band comprises at least a sub-set of the frequency band of 5-3000 MHz.

30. The extended tap unit of claim 29, wherein said standard frequency band comprises at least a sub-set of the frequency band of 5-860 MHz.

31. The extended tap unit of claim 29, wherein said extended frequency band comprises at least a sub-set of the frequency band of 1200-3000 MHz.

32. A method of distributing extended bandwidth signals of a transmission-tiered distribution network supporting a wide frequency band including a CATV-standard frequency band and an extended frequency band, said method comprising:
receiving from an extended-bandwidth tier of said distribution network an extended downstream signal carrying extended downstream data modulated over at least one sub-band of said extended frequency band; and
generating, based on said extended downstream signal, at least one subscriber signal within said standard frequency band, said at least one subscriber signal carrying the extended downstream data of the at least one sub-band modulated over a predetermined sub-band of said standard frequency band, respectively.

33. The method of claim 32 comprising transmitting said at least one converted signal to at least one respective subscriber over a CATV-standard-bandwidth tier of said distribution network.

34. The method of claim 32 comprising selectively generating said at least one subscriber signal based on a control instruction received from said distribution network.

35. The method of claim 34, wherein said extended downstream signal carries standard downstream data modulated over at least a portion of said standard frequency band, and wherein generating said subscriber signal comprises:
generating a standard downstream data signal within said standard frequency band, and an interim downstream data signal within said extended frequency band, by filtering portions of said extended downstream signal, said standard downstream signal carrying said standard downstream data, and said interim downstream data signal carrying the extended downstream data modulated over said at least one frequency sub-band;
selectively converting said interim data signal, based on said control instruction, into an extended data signal carrying the extended downstream data modulated over the predetermined sub-band of said standard frequency band; and
generating said subscriber signal by selectively combining said standard downstream data signal and said extended data signal.

36. The method of claim 35 comprising:
receiving from a CATV-standard-bandwidth tier of said distribution network a standard upstream signal within said CATV-standard frequency sub-band; and
routing said standard upstream signal to said to said extended-bandwidth tier.

37. The method of claim 32 comprising:
splitting said extended downstream signal into a first signal to be provided to said at least one subscriber module, and a second signal to be provided back to said extended bandwidth tier.

38. The method of claim 32, wherein the predetermined portion of said standard frequency band comprises at least a sub-set of the frequency band of 54-68 MHz.

39. The method of claim 32, wherein said wide frequency band comprises at least a sub-set of the frequency band of 5-3000 MHz.

40. The method of claim 39, wherein said standard frequency band comprises at least a sub-set of the frequency band of 5-860 MHz.

41. The method of claim 39, wherein said extended frequency band comprises at least a sub-set of the frequency band of 1200-3000 MHz.

42. A system to transmit extended bandwidth signals over a transmission-tiered distribution network supporting a wide frequency band including a CATV-standard frequency band and an extended frequency band, said system comprising:
at least one head-end to generate an extended downstream signal carrying extended downstream data modulated over at least one sub-band of said extended frequency band, and to transmit said extended downstream signal over an extended bandwidth tier of said distribution network; and
at least one extended tap unit comprising:
an input port to receive said extended downstream signal from said extended-bandwidth tier; and
at least one signal distribution network subscriber module to generate, based on said extended downstream signal, at least one respective subscriber signal within said standard frequency band, said at least one subscriber signal carrying the extended downstream data of the at least one sub-band modulated over a predetermined sub-band of said standard frequency band, respectively.

43. The system of claim 42, wherein said extended tap unit comprises at least one subscriber output port to transmit said at least one converted signal to at least one respective subscriber over a CATV-standard-bandwidth tier of said distribution network.

44. The system of claim 42, herein said extended tap unit comprises a control instructions interface transponder to control said at least one subscriber module to selectively generate said at least one subscriber signal based on a control instruction received from said distribution network.

45. The system of claim 44, wherein said extended downstream signal carries standard downstream data modulated over at least a portion of said standard frequency band, and wherein said subscriber module comprises:
a diplexer to generate a standard downstream data signal within said standard frequency band, and an interim downstream data signal within said extended frequency band, by filtering portions of said extended downstream signal, said standard downstream signal carrying said standard downstream data, and said interim downstream data signal carrying the extended downstream data modulated over said at least one frequency sub-band;
a converter to selectively convert said interim data signal, based on said control instruction, into an extended data signal carrying the extended downstream data modulated over the predetermined sub-band of said standard frequency band; and
a triplexer to generate said subscriber signal by selectively combining said standard downstream data signal and said extended data signal.

46. The system of claim 42, wherein said subscriber module is able to receive from said CATV-standard-bandwidth tier a standard upstream signal within said CATV-standard frequency sub-band; and to transmit said standard upstream signal to said head-end over said extended bandwidth tier.

47. The system of claim 42, wherein said extended tap unit comprises:
a network output port; and
splitter to split said extended downstream signal into a first signal to be provided to said at least one subscriber module, and a second signal to be provided back to said extended bandwidth tier via said network output port.

48. The system of claim 42, wherein the predetermined portion of said standard frequency band comprises at least a sub-set of the frequency band of 54-68 MHz.

49. The system of claim 42, wherein said wide frequency band comprises at least a sub-set of the frequency band of 5-3000 MHz.

50. The system of claim 49, wherein said standard frequency band comprises at least a sub-set of the frequency band of 5-860 MHz.

51. The system of claim 49, wherein said extended frequency band comprises at least a sub-set of the frequency band of 1200-3000 MHz.
